(19) United States
(12) Patent Application Publication
(10) Pub. No.: US 2009/0289388 A1
(43) Pub. Date: Nov. 26, 2009

(54) Material Dosing and Mold Filling Apparatus and Method of Operation

(76) Inventors: Christopher Todd Flynn, Dallas, TX (US); Wyndon Kyle Nix, Gainesville, TX (US); Edward Chad Mitchell, Grapevine, TX (US); Andrew Joseph Gwynn, Anna, TX (US); William Howard Karau, Southlake, TX (US)

Correspondence Address: Mr. Christopher John Rourk;Jackson Walker LLP, 901 Main Street, Suite 6000, DALLAS, TX, 75202, US

(21) Appl. No.: 12/125,667

(22) Filed: May 22, 2008

(51) Int. Cl. B29C 39/24; B29C 39/44

(52) U.S. Cl. 264/71; 425/150

(57) ABSTRACT

An apparatus for manufacturing a molded item having a corner is provided. The apparatus includes a mold support for holding an angled mold having an inside corner. A hopper having an outside corner that corresponds to the inside corner of the mold and a screen at the outside corner mates with the mold. A vibration device is provided for causing a material contained in the hopper to pass through the screen, such as by applying a predetermined force for a predetermined period of time required to fill the mold. Different sized openings in the screen combined with the flowability of the material and the amount of vibration can determine how much material flows through the screen.

### FIELD OF THE INVENTION

The present invention pertains to the field of filling containers and specifically molded items, and more specifically to a mold filling apparatus and method of operation that allows a mold having a corner to be filled in a single procedure.

### BACKGROUND OF THE INVENTION

Molded items are known in the art. Molded items made from materials such as cast masonry compounds require special handling, due to the density and flowability of the materials as well as shape of the finished goods. As a result, when such cast masonry molded items are fabricated, it is often necessary to do so in steps, so as to allow a one section of the molded item to filled, set, or cured before adding or filling a second and subsequent parts of the molded item to the structure. These sequential steps add additional time and processing costs to the manufacturing process for molded items, but generally can not be avoided because the density of the masonry compound prevents molding techniques that can be used for items formed from materials that flow more easily and harden more quickly, such as plastics, from being utilized.

### SUMMARY OF THE INVENTION

In accordance with the present invention, a material dosing and mold filling apparatus and method of operation are provided that allow a molded items with varying cavity volumes, such as one made from cast masonry materials, to be fabricated or filled in a single step.

In accordance with an exemplary embodiment of the present invention, an apparatus for manufacturing a molded item having a corner is provided. The apparatus includes a mold support for holding an angled mold having an inside corner. A hopper having an outside corner that corresponds to the inside corner of the mold and a screen at the outside corner mates with the mold. A vibration device is provided for causing a material contained in the hopper to pass through the screen, such as by applying a predetermined force for a predetermined period of time required to fill the mold. Different sized openings in the screen combined with the flowability of the material and the amount of vibration can determine how much material flows through the screen.

Those skilled in the art will further appreciate the advantages and superior features of the invention together with other important aspects thereof on reading the detailed description that follows in conjunction with the drawings.

### BRIEF DESCRIPTION OF THE DRAWINGS

FIG. 1 is a diagram of a material dosing apparatus for filling a corner mold in accordance with an exemplary embodiment of the invention;

FIG. 2 is a diagram of a material dosing apparatus for filling a corner mold in accordance with an exemplary embodiment of the invention;

FIG. 3 is a diagram showing placement of a mold cover on a mold in accordance with an exemplary embodiment of the present invention;

FIG. 4 is a diagram of a method for making a molded item having an inside corner in accordance with an exemplary embodiment of the present invention;

FIG. 5 is a diagram of a material dosing apparatus for filling a container in accordance with an exemplary embodiment of the invention;

FIG. 6 is a diagram of a method for filling a container in accordance with an exemplary embodiment of the present invention; and

FIG. 7 is a diagram of a system for controlling a filling apparatus in accordance with an exemplary embodiment of the present invention.

### DETAILED DESCRIPTION OF PREFERRED EMBODIMENTS

In the description that follows, like parts are marked throughout the specification and drawings with the same reference numerals. The drawing figures might not be to scale and certain components can be shown in generalized or schematic form and identified by commercial designations in the interest of clarity and conciseness.

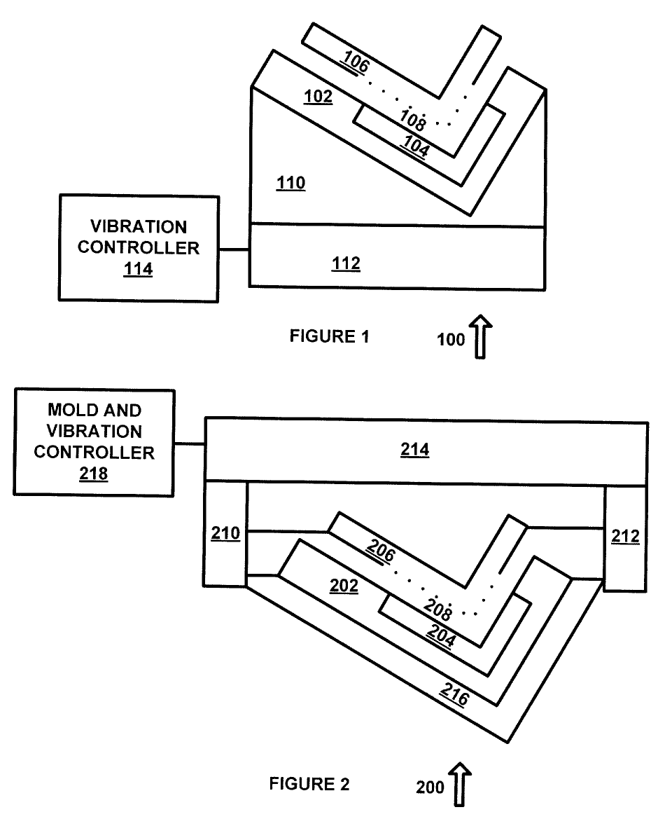

FIG. 1 is a diagram of an apparatus 100 for filling a corner mold in accordance with an exemplary embodiment of the invention. Apparatus 100 allows a mold for an item having an inside corner to be filled in a single process, so as to eliminate the need to perform multiple steps to form different sides of the item. Apparatus 100 can also be used for other suitable molded items, included molded items having shapes other than those including an inside corner.

Apparatus 100 includes mold 102, which includes a mold cavity 104 for forming a molded item. In one exemplary embodiment, the molded item formed in mold cavity 104 can be used for an outside corner, such as for external corners of buildings, columns, or other structures, where the molded item is used to provide a veneer or for other suitable purposes. Mold 102 can be prepared prior to placement in apparatus 102, such as by cleaning debris left over in mold cavity 104 from forming previously molded items, by providing a lubricant or other coatings on the surfaces of mold cavity 104 to improve the ease of removing the molded item, or in other suitable manners.

Hopper 106 is configured to mate with mold 102, and includes screen 108 that is used to transfer a suitable filler material such as a masonry compound from hopper 106 to mold cavity 104. In one exemplary embodiment, screen 108 is a 1.5″ flattened expanded metal #9 mesh wire mesh or other suitable screens that are selected based on the ability to hold the filler material in place prior to vibration, such that the filler material does not flow through screen 108 until apparatus 108 is configured to fill mold 102.

Mold support 110 holds mold 102 and allows mold 102 to be vibrated by vibration unit 112. In one exemplary embodiment, vibration unit 112 can include two 0.5 horsepower electric motors rated to provide 1100 pounds force based upon eccentric weight alignment, such as a VIBCO 2P-450-1 single phase vibrator or a VIBCO 2P-450-3 three phase vibrator, available from VIBCO Vibrators, 75 Stilson Road, Wyoming, R.I., 02898, or other suitable devices. Vibration can be provided to the mold, the hopper, the mold and the hopper in combination, or in other suitable manners.

Vibration controller 114 provides control signals to vibration unit 112 to cause filler material from hopper 106 to flow into mold cavity 104. In one exemplary embodiment, vibration controller 114 can include a sensor input to prevent operation of vibration unit 112 prior to proper placement of hopper 106 into mold 102. In another exemplary embodiment, vibration control 114 can cause vibration unit 112 to provide 680 pounds force for a period of thirty seconds in order to transfer sufficient filler material from hopper 106 to mold cavity 104 to fill mold cavity 104. Vibration also helps to consolidate the fill material in the mold, such as to cause a masonry compound to flow into corners or detail features of the mold.

In operation, apparatus 100 allows a mold for a molded item having an inside corner to be filled in a single operation, using a hopper having an outside corner with a screen that holds a filler material in place until vibration force is applied, at which time the filler material passes through the screen and fills the mold cavity. The mold cavity volume can be constrained by the amount or volume of materials contained in hopper 106. In this manner, a mold cover can be placed over the mold after it has been filled and the filled and covered mold can be cured, such as by placement in an oven, by allowing time to pass, or in other suitable manners.

FIG. 2 is a diagram of an apparatus 200 for filling a corner mold in accordance with an exemplary embodiment of the invention. Apparatus 200 allows a mold for an item having an inside corner to be hydraulically or mechanically lifted to fit against a hopper having an outside corner. Apparatus 200 can also be used for other suitable molded items, included molded items having shapes other than those including an inside corner.

Apparatus 200 includes mold 202, which includes a mold cavity 204 for forming a molded item. In one exemplary embodiment, the molded item formed in mold cavity 204 can be used for an outside corner, such as for external corners of buildings, columns, or other structures, where the molded item is used to provide a veneer or for other suitable purposes. Mold 202 can be prepared prior to placement in apparatus 202, such as by cleaning debris left over in mold cavity 204 from forming previously molded items, by providing a lubricant or other coatings on the surfaces of mold cavity 204 to improve the ease of removing the molded item, or in other suitable manners.

Hopper 206 is configured to mate with mold 202, and includes screen 208 that is used to transfer a suitable filler material such as a masonry compound from hopper 206 to mold cavity 204. In one exemplary embodiment, screen 208 is a 1.5″ flattened expanded metal #9 mesh wire mesh or other suitable screens that are selected based on the ability to hold the filler material in place prior to vibration, such that the filler material does not flow through screen 208 until apparatus 208 is configured to fill mold 202.

Mold support 216 holds mold 202 and allows mold 202 to be placed into position by hydraulic placement devices 210 and 212. Hydraulic placement devices 210 and 212 can move mold 202 upwards until it mates with hopper 206, can move hopper 206 downward until it mates with mold 202, can move both mold 202 and hopper 206 towards each other until they mate, or can perform other suitable functions. Once 202 and hopper 206 are in place, they are vibrated by vibration unit 214. In one exemplary embodiment, vibration unit 214 can include two 0.5 horsepower electric motors rated to provide 1100 pounds force based upon eccentric weight alignment, such as a VIBCO 2P-450-1 single phase vibrator or a VIBCO 2P-450-3 three phase vibrator, available from VIBCO Vibrators, 75 Stilson Road, Wyoming, R.I., 02898, or other suitable devices.

Mold and vibration controller 218 provides control signals to vibration unit 214 to cause filler material from hopper 206 to flow into mold cavity 204. In one exemplary embodiment, mold and vibration controller 218 can include a sensor input, such as from hydraulic placement devices 210 and 212, to determine when mold 202 and hopper 206 are in proper position and to prevent operation of vibration unit 214 prior to proper placement of hopper 206 into mold 202. In another exemplary embodiment, mold and vibration controller 218 can cause vibration unit 214 to provide 680 pounds force for a period of thirty seconds in order to transfer sufficient filler material from hopper 206 to mold cavity 204 to fill mold cavity 204.

In operation, apparatus 200 allows a mold for a molded item having an inside corner to be filled in a single operation, using a hopper having an outside corner with a screen that holds a filler material in place until vibration force is applied, at which time the filler material passes through the screen and fills the mold cavity. In this manner, a mold cover can be placed over the mold after it has been filled and the filled and covered mold can be cured, such as by placement in an oven, by allowing time to pass, or in other suitable manners.

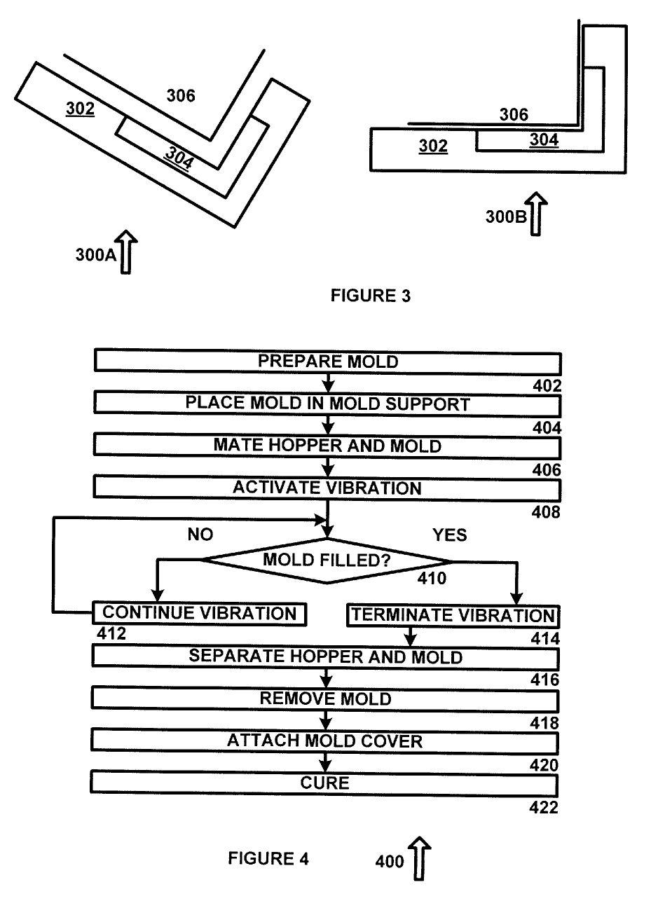

FIG. 3 is a diagram showing placement of a mold cover on a mold in accordance with an exemplary embodiment of the present invention. In 300A, mold 302 is oriented so as to minimize the gravitation force on a filler material in mold cavity 304. A mold cover 306 is placed over the top of mold 302, and mold 302 is then oriented as shown in 300B so as to allow the base of mold 302 to be placed on a flat surface, such as for curing, for transfer to an oven, or for other suitable purposes. As shown in 300B, mold cover 306 prevents the filler material in mold cavity 304 from flowing, and allows the filler material to cure so as to form a molded item having an inside corner.

In operation, the process shown in FIG. 3 can be used to cover a mold for an item having an inside corner so as to allow the mold to be filled in a first position and then transferred to a second position for curing. This process can be used where the filler material does not readily flow but still requires support during the curing process, such as a masonry filler compound or other suitable filler materials.

FIG. 4 is a diagram of a method 400 for making a molded item having an inside corner in accordance with an exemplary embodiment of the present invention. Method 400 begins at 402, where a mold having a mold cavity is prepared for placement in a press or other suitable apparatuses. In one exemplary embodiment, the mold and mold cavity can be washed, such as by brushing, using pressurized water, or in other suitable manners. The mold cavity can also be treated with a coating material to improve the ease of removing the molded item from the mold cavity, and other suitable preparations can also or alternatively be performed. The method then proceeds to 404.

At 404, the mold is placed in a mold support, such as by sliding the mold into the mold support laterally, by vertically placing the mold on the mold support, or in other suitable manners. The mold can also be prepared after it has been placed on the mold support where suitable. The method then proceeds to 406.

At 406, a hopper is mated to the mold. The hopper can be lowered onto the mold, the mold can be raised to mate with the hopper, the mold and the hopper can each be moved towards the other, or other suitable processes can be used. Hydraulic devices, motorized pulleys, or other suitable drivers can also or alternatively be used to mate the hopper to the mold. The method then proceeds to 408.

At 408, vibration of the mold and hopper is activated. In one exemplary embodiment, a sensor can be used to inhibit operation of a vibration device until the mold and hopper are properly configured, a programmable controller can be used to sequence placement and vibration of the mold and hopper, or other suitable processes can also or alternatively be used. Likewise, the vibration force, length of vibration and other suitable variables can be determined, such as from a user settings, based on a control device on a mold, or in other suitable manners. The method then proceeds to 410.

At 410, it is determined whether the mold is filled. In one exemplary embodiment, a predetermined time can be used to vibrate the mold and hopper in order to fill the mold. In another exemplary embodiment, a sensor or other suitable device can be used to determine whether the mold has been filled, or other suitable processes or devices can also or alternatively be used. If it is determined that the mold is not filled, the method proceeds to 412 where vibration continues and the method returns to 410. Otherwise, the method proceeds to 414.

At 414, vibration is terminated, such as by removing power from a vibration device, motor, or other suitable vibrating units. The method then proceeds to 416, where the mold and hopper are separated. In one exemplary embodiment, a hydraulic device can be used to raise the hopper away from the mold, to lower the mold away from the hopper, to move the mold and hopper away from each other, or other suitable processes can also or alternatively be used. The method then proceeds to 418.

At 418, the mold is removed from the vibration apparatus, such as by sliding the mold laterally, by raising the mold vertically, or in other suitable manners. The method then proceeds to 420, where a mold cover is placed on top of the mold. In one exemplary embodiment, the mold cover can be placed on the mold while it is still in an angled position, so as to minimize or prevent movement of a filler material in the mold cavity. The filler material can also be screeded to level the filler material and ensure that the mold cavity is uniformly filled, and other suitable processes can also or alternatively be performed. The method then proceeds to 422, where the mold is cured, such as by placing the mold in an oven, by allowing time to pass sufficient to allow the filler material to cure, or in other suitable manners.

In operation, method 400 allows a molded item having an interior corner to be formed, such as where a hopper is provided having a screen that forms an outside corner that mates with the interior corner of the mold. A filler material can be held in the hopper by coordinating the filler material and screen so that the filler material does not flow through the screen until a vibration force is applied. Likewise, method 400 can be used in other suitable applications, such as to transfer a filler material to a suitable mold or container, including molds or containers for items having other suitable shapes and/or volumes.

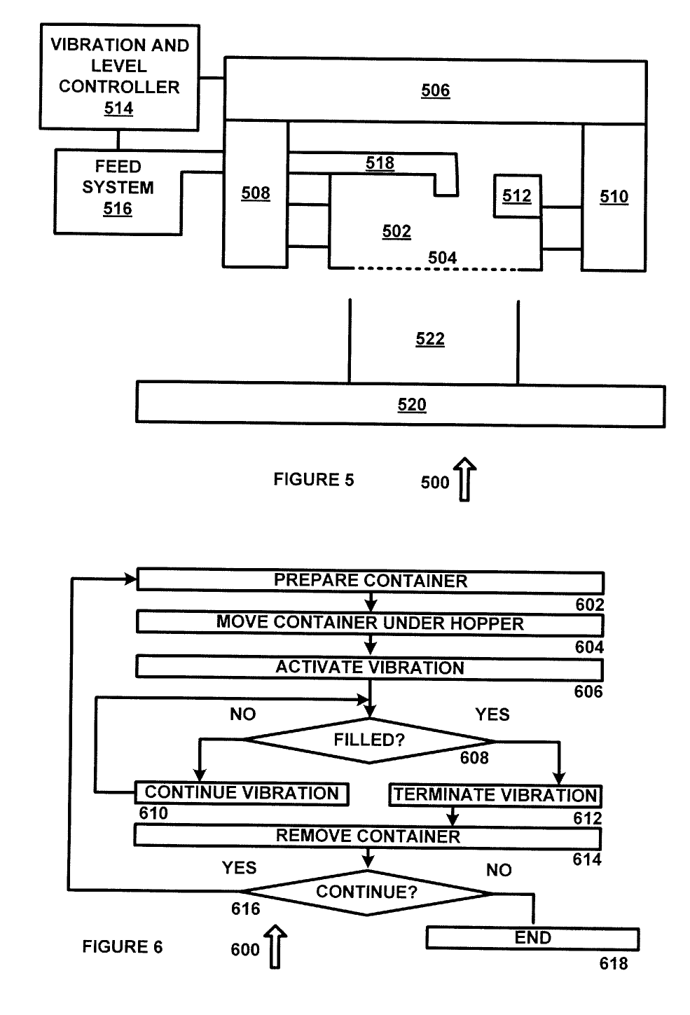

FIG. 5 is a diagram of an apparatus 500 for filling a container in accordance with an exemplary embodiment of the invention. Apparatus 500 can be used to fill containers with fluids (such as water, oil, paint, or other suitable fluids), dry mixes (such as grains, dry masonry mixes, particulates, or other suitable dry mixes), wet mixes (such as wet plaster, wet concrete, or other suitable wet mixes), or other suitable materials.

Apparatus 500 includes hopper 502 having a screen 504 disposed at the bottom. Hopper 502 can be rectangular as shown or can utilize other suitable shapes, and screen 504 can be disposed as needed to provide material into container 522. In one exemplary embodiment, hopper 502 can be cone shaped and screen 504 can form the tip of the cone, can be circular, or can have other suitable configurations. The mesh size of screen 504 and material used to form screen 504 are selected in order to optimize control of the delivery of material through screen 504, such as by using a smaller mesh and corrosion resistant material for corrosive liquids, a larger mesh for large particulates, and other suitable configurations. Likewise, a permeable barrier can be used in place of a screen material where suitable, such as a configuration of equally spaced parallel rods, a perforated metal barrier, a plurality of screens in series, a combination of permeable barriers, or other suitable permeable barriers.

Feed system 516 and chute 518 are used to maintain a fill level of material inside of hopper 502 at a predetermined level, to periodically refill hopper 502, or to otherwise provide material to hopper 502. In one exemplary embodiment, level sensor 512 can be used to maintain a level of material between predetermined low and high limits, such as by activating feed system 516 when the level of material in hopper 502 reaches the low level and deactivating feed system 516 when the level of material reaches the high level, or in other suitable manners.

Vibration and level controller 514 controls the operation of feed system 516 and vibration unit 506. In one exemplary embodiment, vibration and level controller 514 can activate feed system 516 periodically based on a number of containers 504 that have been filled, based on data received from level sensor 512, or in other suitable manners. Vibration and level controller 514 can also control the operation of vibration unit 506, such as by activating vibration unit for a predetermined period of time at a predetermined force when container 522 is moved under hopper 502 by conveyor system 520 or in other suitable manners. Hopper supports 508 and 510 can be stationary, hydraulically controlled or otherwise configured to support hopper 502.

In operation, apparatus 500 can be used to fill containers with a predetermined quantity of material by applying a vibrational force to a hopper having a screen or other suitable permeable barrier disposed at a bottom surface. Apparatus 500 can be used to fill a suitable container with a suitable material, such as a mold (e.g. filled with masonry mix, epoxy, glass, plastic), a barrel (e.g. filled with oil, beverages), a bottle (e.g. filled with condiments, foodstuff), a rail car (e.g. filled with gravel, cotton seed), a box (e.g. filled with packing material, sawdust), a carton (e.g. filled with nails, ball bearings), or other combinations of containers and materials. In one exemplary embodiment, apparatus 500 can be used to fill a container with a material that can be dispensed through a screen or other permeable barrier, where the material exhibits a controllable flow or fill rate through the screen or permeable barrier when subjected to a predetermined vibrational force. Vibration can also or alternatively be applied to the container to help consolidate material in the container.

FIG. 6 is a diagram of a method 600 for filling a container in accordance with an exemplary embodiment of the present invention. Method 600 begins at 602 where a container is prepared, such as by cleaning the container, applying a pigment or lubricant, or otherwise preparing the container. The method then proceeds to 604 where the container is moved under a hopper, such as by moving the container into position using a conveyor system, by manual placement, or in other suitable manners. The method then proceeds to 606.

At 606, a vibration unit is activated to apply a predetermined vibrational force to the hopper so as to cause material contained in the hopper to flow through a screen or other suitable permeable barrier into the container. In one exemplary embodiment, the material can be coordinated with the screen or permeable barrier so as to result in a predetermined material flow rate, where the volume of material provided to the container can be measured based on the length of time that vibrational force is applied, the level of vibrational force, or in other suitable manners. The method then proceeds to 608.

At 608, it is determined whether the container has been filled. In one exemplary embodiment, fill can be determined from the length of time of vibration, using a fill sensor, or in other suitable manners. If it is determined at 608 that the container is not filled, the method proceeds to 610 where vibration continues, after which the method returns to 608. Otherwise, the method proceeds to 612, where the vibrational force is terminated. The method then proceeds to 614.

At 614, the container is removed, such as by activating a conveyor system, using manual processes, or in other suitable manners. The method then proceeds to 616 where it is determined whether another container should be filled. In one exemplary embodiment, method 600 can be used in a continuous container filling process, a sensor can be used to determine whether the filled container has been removed, or other suitable processes can be used. If it is determined that another container should be filled, the method returns to 602, otherwise the method proceeds to 618 and terminates.

In operation, method 600 can be used to fill containers such as molds, barrels, bottles, rail cars, boxes, cartons, or other suitable containers with a suitable material, such as a material that can be delivered through a screen or other permeable barrier at a controllable delivery rate, by applying a vibrational force to a hopper containing the material, where the hopper includes a screen or permeable barrier disposed at the bottom of the hopper, a corner of the hopper, or in other suitable locations.

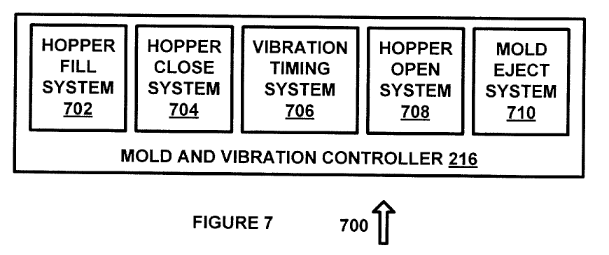

FIG. 7 is a diagram of a system 700 for controlling a filling apparatus in accordance with an exemplary embodiment of the present invention. System 700 can be implemented in hardware, software, or a suitable combination of hardware and software, and can be one or more software systems operating on a programmable controller or other suitable platforms. As used herein, a hardware system can include a combination of discrete components, an integrated circuit, an application-specific integrated circuit, a field programmable gate array, or other suitable hardware. A software system can include one or more objects, agents, threads, lines of code, subroutines, separate software applications, two or more lines of code or other suitable software structures operating in two or more software applications or on two or more processors, or other suitable software structures. In one exemplary embodiment, a software system can include one or more lines of code or other suitable software structures operating in a general purpose software application, such as an operating system, and one or more lines of code or other suitable software structures operating in a specific purpose software application. As used herein, the term “coupled” and its cognate terms such as “couples” or “couple,” can include a physical connection (such as a wire, optical fiber, or a telecommunications medium), a virtual connection (such as through randomly assigned memory locations of a data memory device or a hypertext transfer protocol (HTTP) link), a logical connection (such as through one or more semiconductor devices in an integrated circuit), or other suitable connections. In one exemplary embodiment, a communications medium can be a network or other suitable communications media.

System 700 includes mold and vibration controller 216 and hopper fill system 702, hopper close system 704, vibration timing system 706, hopper open system 708 and mold eject system 710. Hopper fill system 702 receives a user entered command, sensor data or other suitable data and activates or deactivates a material transport system to transport material to a hopper. In one exemplary embodiment, hopper fill system 702 receives a low level sensor indication that indicates that a level of material in a hopper is below a predetermined low level and activates the material transport system. Hopper fill system 702 can then receive a high level sensor indication that indicates that the hopper is filled and can deactivate the material transport system. In another exemplary embodiment, hopper fill system 702 can operate the material transport system periodically, after a predetermined number of molds or containers have been filled, or in other suitable manners.

Hopper close system 704 actuates a closing mechanism for closing a hopper against a mold or container, and deactivates the closing mechanism where suitable. In one exemplary embodiment, hopper close system 704 can receive sensor data that indicates that a mold has been placed in a mold support, a manual control, or other suitable data, and activates an electric, hydraulic, pneumatic or other suitable mechanism that causes the hopper to be placed in contact with a mold or container, such as where the hopper is used to fill a mold. Hopper close system 704 can receive additional data, such as sensor data that indicates that the hopper and mold have come into contact, an inhibit signal that prohibits operation when the mold is not in a mold support or otherwise in position, or other suitable data, and can activate or deactivate the closing mechanism accordingly.

Vibration timing system 706 receives control data and actuates a vibration system for a predetermined period of time at a predetermined force or in other suitable manners. In one exemplary embodiment, vibration timing system 706 can receive control data from hopper close system 704 that indicates that a hopper and/or container is in position, an inhibit override signal, or other suitable data, and can activate a vibration system to cause material contained within the hopper to pass through a screen or other suitable permeable barrier. In another exemplary embodiment, vibration timing system 706 can operate in response to a manual control, based on sensor data that indicates whether a mold or container is filled, or other suitable data.

Hopper open system 708 activates a suitable mechanism to cause a hopper to separate from a mold or other container, such as to allow the mold or other container to be removed manually, by a conveyor, or in other suitable manners. In one exemplary embodiment, an electric, hydraulic, pneumatic or other suitable mechanism can be used to move the hopper from a fill position to a standby position, such as to allow an empty mold or container to be placed in position for filling.

Mold eject system 710 removes a mold from a fill position, such as by using a conveyor system, by ejecting the mold for manual handling, or in other suitable manners. In one exemplary embodiment, mold eject system 710 can be used to eject a mold from a mold support, such as where the molds are moved into location by conveyor or other suitable mechanisms, and are then loaded into a mold support, filled and ejected back onto the conveyor.

In operation, system 700 controls the operation of a mold or container filling apparatus that uses vibrational force to cause a material to pass through a screen or other permeable barrier. System 700 allows molds or other containers to be filled, and prevents inadvertent operation of the fill process, such as to prevent operation of the fill process when no mold is in position, when the mold is not seated against the hopper, or at other times when operation should be prevented.

Although exemplary embodiments of a system and method of the present invention have been described in detail herein, those skilled in the art will also recognize that various substitutions and modifications can be made to the systems and methods without departing from the scope and spirit of the appended claims.

What is claimed is:

1. An apparatus for manufacturing a molded item having a corner comprising:
a mold support for holding an angled mold having an inside corner;
a hopper having an outside corner that corresponds to the inside corner of the mold and a screen at the outside corner; and
a vibration device for causing a material contained in the hopper to pass through the screen.

2. The apparatus of claim 1 further comprising an assembly for mating the mold support to the hopper when the angled mold is in position.

3. The apparatus of claim 1 further comprising a vibration controller for controlling a length of time of operation of the vibration device.

4. The apparatus of claim 1 further comprising a vibration controller for controlling an amount of force provided by the vibration device.

5. The apparatus of claim 2 further comprising mold controller for controlling the operation of the assembly for mating the mold support to the hopper.

6. The apparatus of claim wherein the mold controller is for preventing operation of the vibration device when the mold support is not mated to the hopper.

7. A method for manufacturing a molded item having a corner comprising:
placing a mold having an inside corner in a mold support;
placing the mold in contact with a hopper having an outside corner; and
vibrating the mold and the hopper to transfer material from the hopper to the mold.

8. The method of claim 7 wherein placing the mold having the inside corner in the mold support comprise:
preparing the mold external to the mold support; and
sliding the mold into the mold support.

9. The method of claim 7 wherein placing the mold in contact with the hopper having an outside corner comprises raising the mold until it contacts the hopper.

10. The method of claim 7 wherein placing the mold in contact with the hopper having an outside corner comprises lowering the hopper until it contacts the mold.

11. The method of claim 7 wherein vibrating the mold and the hopper to transfer the material from the hopper to the mold comprises vibrating the mold and the hopper with a predetermined force to cause a material contained in the hopper to pass through a screen at the outside corner of the hopper.

12. The method of claim 7 wherein vibrating the mold and the hopper to transfer the material from the hopper to the mold comprises vibrating the mold and the hopper for a predetermined time to cause a predetermined amount of material contained in the hopper to fill the mold.

13. The method of claim 7 further comprising placing a mold cover over the mold after vibrating the mold and the hopper.

14. An apparatus for manufacturing a molded item having a corner comprising:
means for holding an angled mold having an inside corner;
a hopper having an outside corner that corresponds to the inside corner of the mold and a screen at the outside corner; and
means for causing a material contained in the hopper to pass through the screen.

15. The apparatus of claim 14 further comprising means for mating the mold support to the hopper.

16. The apparatus of claim 14 further comprising means for controlling a length of time of operation of the vibration device.

17. The apparatus of claim 14 further comprising means for controlling an amount of force provided by the vibration device.

18. The apparatus of claim 15 further comprising means for preventing operation of the vibration device when the mold support is not mated to the hopper.
